(19) United States
(12) Patent Application Publication
(10) Pub. No.: US 2012/0102035 A1
(43) Pub. Date: Apr. 26, 2012

(54) Data Embedding Methods, Embedded Data Extraction Methods, Truncation Methods, Data Embedding Devices, Embedded Data Extraction Devices And Truncation Devices

(76) Inventors: Te Li, Singapore (SG); Susanto Rahardja, Singapore (SG); Haiyan Shu, Singapore (SG); Ti Eu Chan, Singapore (SG); Haibin Huang, Singapore (SG)

(21) Appl. No.: 13/260,201

(22) PCT Filed: Mar. 25, 2010
(86) PCT No.: PCT/SG2010/000115

§ 371 Date: Jan. 11, 2012

(30) Foreign Application Priority Data
Mar. 27, 2009 (SG) 200902140-3

(51) Int. Cl. G06F 17/30

(52) U.S. Cl. 707/737; 707/E17.089

(57) ABSTRACT

In an embodiment, a data embedding method may be provided. The data embedding method may include inputting data to be encoded and data to be embedded; grouping the data to be encoded into a first set and a second set, based on an entropy of the data to be encoded; and embedding the data to be embedded into the data to be encoded by replacing a pre-determined part of the second set with the data to be encoded so that the first set remains free of data to be embedded.

### TECHNICAL FIELD

Embodiments relate to data embedding methods, embedded data extraction methods, truncation methods, data embedding devices, embedded data extraction devices and truncation devices.

### BACKGROUND

Various kinds of data may be encoded, for example audio data or video data. Furthermore, it may be desired to include further information, for example information of other kind than the kind of information of the encoded data into the encoded data. For example it may be desired to embed text data (for example lyrics or subtitles) into audio data or video data.

### SUMMARY

In various embodiments, a data embedding method may be provided. The data embedding method may include inputting data to be encoded and data to be embedded; grouping the data to be encoded into a first set and a second set, based on an entropy of the data to be encoded; and embedding the data to be embedded into the data to be encoded by replacing a pre-determined part of the second set with the data to be encoded so that the first set remains free of data to be embedded.

In various embodiments, an embedded data extraction method may be provided. The embedded data extraction method may include inputting data including a first set and a second set; decoding the first set using entropy decoding; combining the decoded first set and a first pre-determined part of the second set to generate data to be further decoded; and copying a second pre-determined part of the second set to generate data that has been embedded, so that the data that has been embedded is independent from the first set.

In various embodiments, a data embedding device may be provided. The data embedding device may include an input circuit configured to input data to be encoded and data to be embedded; a grouping circuit configured to group the data to be encoded into a first set and a second set, based on an entropy of the data to be encoded; and an embedding circuit configured to embed the data to be embedded into the data to be encoded by replacing a pre-determined part of the second set with the data to be encoded so that the first set remains free of data to be embedded.

In various embodiments, an embedded data extraction device may be provided. The an embedded data extraction device may include an input circuit configured to input data including a first set and a second set; a decoding circuit configured to decode the first set using entropy decoding; a combiner configured to combine the decoded first set and a first pre-determined part of the second set to generate data to be further decoded; and a data extractor configured to copy a second pre-determined part of the second set to generate data that has been embedded, so that the data that has been embedded is independent from the first set.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments of the invention are described with reference to the following drawings, in which:

FIG. 1 shows a flow diagram illustrating a data embedding method according to an embodiment;

FIG. 2 shows a flow diagram illustrating an embedded data extraction method according to an embodiment;

FIG. 3 shows a flow diagram illustrating an embedded data extraction method according to an embodiment;

FIG. 4 shows a flow diagram illustrating a truncation method according to an embodiment;

FIG. 5 shows a data embedding device according to an embodiment;

FIG. 6 shows a data embedding device according to an embodiment;

FIG. 7 shows an embedded data extraction device according to an embodiment;

FIG. 8 shows an embedded data extraction device according to an embodiment;

FIG. 9 shows a truncation device according to an embodiment;

FIG. 10 shows an example of embedded data according to an embodiment;

FIG. 11 shows an encoder according to an embodiment;

FIG. 12 shows a decoder according to an embodiment;

FIG. 13 shows a bit-plane coding sequence according to an embodiment;

FIG. 14 shows a bitstream structure according to an embodiment;

FIG. 15 shows an embodiment of truncation;

FIG. 16 shows a diagram illustrating the basic concept of embedding data according to an embodiment;

FIG. 17 shows a diagram illustrating the compatibility feature according to an embodiment;

FIG. 18A shows a diagram illustrating an embedding method according to an embodiment;

FIG. 18B shows a diagram illustrating a truncation method according to an embodiment;

FIG. 19 shows a diagram illustrating an embedding method according to an embodiment;

FIG. 20 shows a bit-plane coding sequence according to an embodiment;

FIG. 21 shows a bit-plane coding sequence according to an embodiment; and

FIG. 22 shows a bit-plane coding sequence according to an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

The word “exemplary” is used herein to mean “serving as an example, instance, or illustration”. Any embodiment or design described herein as “exemplary” is not necessarily to be construed as preferred or advantageous over other embodiments or designs.

The various devices, as will be described in more detail below, according to various embodiments may comprise a memory which is for example used in the processing carried out by the various devices. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

According to various embodiments, a set may be understood as a non-empty set.

In various embodiments, features may be explained for devices, and in some other embodiments, features may be explained for methods. It however will be understood that features for devices may be also provided for the methods, and vice versa.

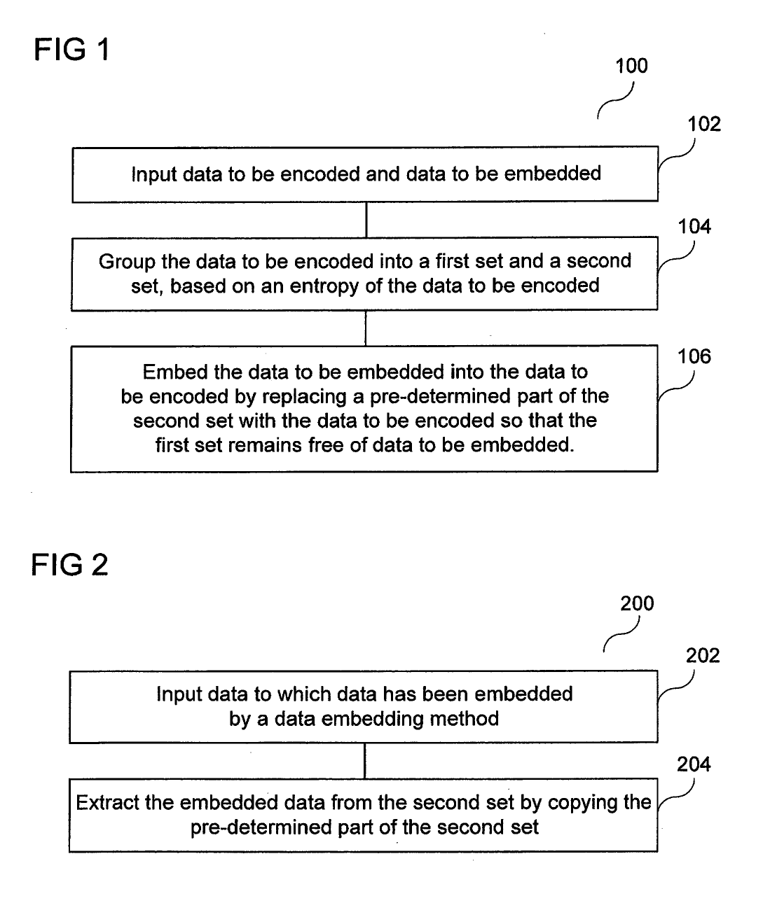

FIG. 1 shows a flow diagram 100 illustrating a data embedding method according to an embodiment. In 102, data to be encoded and data to be embedded may be inputted. In 104, the data to be encoded may be grouped into a first set and a second set, based on an entropy of the data to be encoded. In 106, the data to be embedded may be embedded into the data to be encoded by replacing a pre-determined part of the second set with the data to be encoded so that the first set remains free of data to be embedded.

In various embodiments, an entropy of the data to be encoded may be computed based on the radio of the sum of absolute values of the data and the length of the data.

In various embodiments, the first set may be BPGC/CBAC coded data, as will be explained below.

In various embodiments, the data to be encoded may include data selected from a list consisting of: audio data; video data; transformation coefficients of audio data; Fourier transform coefficients of audio data; cosine transformation coefficients of audio data; discrete cosine transformation coefficients of audio data; modified discrete cosine transformation coefficients of audio data; integer modified discrete cosine transformation coefficients of audio data; discrete sine transformation coefficients of audio data; wavelet transformation coefficients of audio data; discrete wavelet transformation coefficients of audio data; transformation coefficients of video data; Fourier transform coefficients of video data; cosine transformation coefficients of video data; discrete cosine transformation coefficients of video data; modified discrete cosine transformation coefficients of video data; integer modified discrete cosine transformation coefficients of video data; discrete sine transformation coefficients of video data; wavelet transformation coefficients of video data; and discrete wavelet transformation coefficients of video data.

In various embodiments, the data to be encoded may include a plurality of data items.

In various embodiments, each data item may represent a transform coefficient.

In various embodiments, each transform coefficient may represent a frequency of audio data represented by the data to be encoded.

In various embodiments, data to be embedded may be embedded in the data to be encoded by replacing pre-determined parts of the second set, from a high frequency to a low frequency.

In various embodiments, data to be embedded may be embedded in the data to be encoded by replacing pre-determined parts of the second set, from a low frequency to a high frequency.

In various embodiments, the data to be encoded may be provided in bit-planes for each of the plurality of data items.

In various embodiments, the first set and the second set may be disjoint.

In various embodiments, the set union of the first set and the second set may be the data to be encoded.

In various embodiments, the data embedding method may further include grouping the second set into a third set and a fourth set, based on the entropy of the data to be encoded.

In various embodiments, the third set may be lazy mode coded data, as will be explained below.

In various embodiments, the fourth set may be the LEMC coded data, as will be explained below.

In various embodiments, the data to be embedded into the data to be encoded may be embedded so that the third set remains free of data to be embedded.

In various embodiments, the data to be embedded into the data to be encoded may be embedded so that the fourth set remains free of data to be embedded.

In various embodiments, the data to be embedded into the data to be encoded may be embedded so that the data items of the third set with less than a pre-determined number of bit-planes remain free of data to be embedded.

In various embodiments, the third set and the fourth set may be disjoint.

In various embodiments, the set union of the third set and the fourth set may be the second set.

In various embodiments, the data embedding method may further include determining a threshold based on the entropy of the data to be encoded.

In various embodiments, the data embedding method may further include determining a respective threshold for each of the plurality of data items based on the entropy of the data to be encoded.

In various embodiments, each data item may represent a scalefactor band, as will be explained below.

In various embodiments, determining the respective thresholds for each of the plurality of data items may include setting the respective threshold L[s] of the respective data item s to:

L[s]=max{L′εZ|(2^{m[s]-L′]+1}·N[s])≧A[s]},

wherein Z may be the positive and negative integer numbers, m[s] may be the total number of the bit-planes in the scalefactor band, N[s] may be the length of the data vector to be encoded, and A[s] may be the sum of the absolute values of the data vectors to be encoded.

In various embodiments, grouping the data to be encoded into a first set and a second set may further include grouping the data to be encoded into the first set and the second set, based on the determined respective thresholds.

In various embodiments, grouping the data to be encoded into a first set and a second set may further include grouping a data item into the first set, if the number of bit-planes of the data item is higher than the threshold for the data item.

In various embodiments, grouping the data to be encoded into a first set and a second set may further include grouping a data item into the second set, if the number of bit-planes of the data item is lower to or equal than the threshold for the data item.

In various embodiments, grouping the data to be encoded into a first set and a second set may further include grouping the first pre-determined number of bit-planes of a data item into the first set, if the number of bit-planes of the data item is higher than the threshold for the data item.

In various embodiments, the pre-determined number of bit-planes may be equal to the value of the respective threshold.

In various embodiments, grouping the data to be encoded into a first set and a second set may further include grouping the last but the first pre-determined number of bit-planes of a data item into the second set, if the number of bit-planes of the data item is higher than the threshold for the data item.

In various embodiments, grouping the data to be encoded into a first set and a second set may further include grouping a data item into the second set, if the number of bit-planes of the data item is lower or equal than the threshold for the data item.

In various embodiments, grouping the second set into a third set and a fourth set may further include grouping the last but the first pre-determined number of bit-planes of a data item into the third set, if the number of bit-planes of the data item is higher than the threshold for the data item.

In various embodiments, grouping the second set into a third set and a fourth set may further include grouping a data item into the fourth set, if the number of bit-planes of the data item is lower or equal than the threshold for the data item.

In various embodiments, the data embedding method may further include entropy encoding of the first set.

In various embodiments, the data embedding method may further include context-based entropy encoding of the first set.

In various embodiments, entropy encoding may include Huffman encoding.

In various embodiments, entropy encoding may include arithmetic encoding.

In various embodiments, entropy encoding may include context-based arithmetic coding.

In various embodiments, the data embedding method may further include outputting the third set, without further encoding.

In various embodiments, the data embedding method may further include low energy mode coding of the fourth set.

In various embodiments, the data to be embedded may include at least one of data selected from a list of: image data; text data; and encoded audio data.

FIG. 2 shows a flow diagram 200 illustrating an embedded data extraction method according to an embodiment. In 202, data to which data has been embedded by a data embedding method, for example by one of the data embedding methods described above, may be inputted. In 204, the embedded data may be extracted from the second set by copying the pre-determined part of the second set.

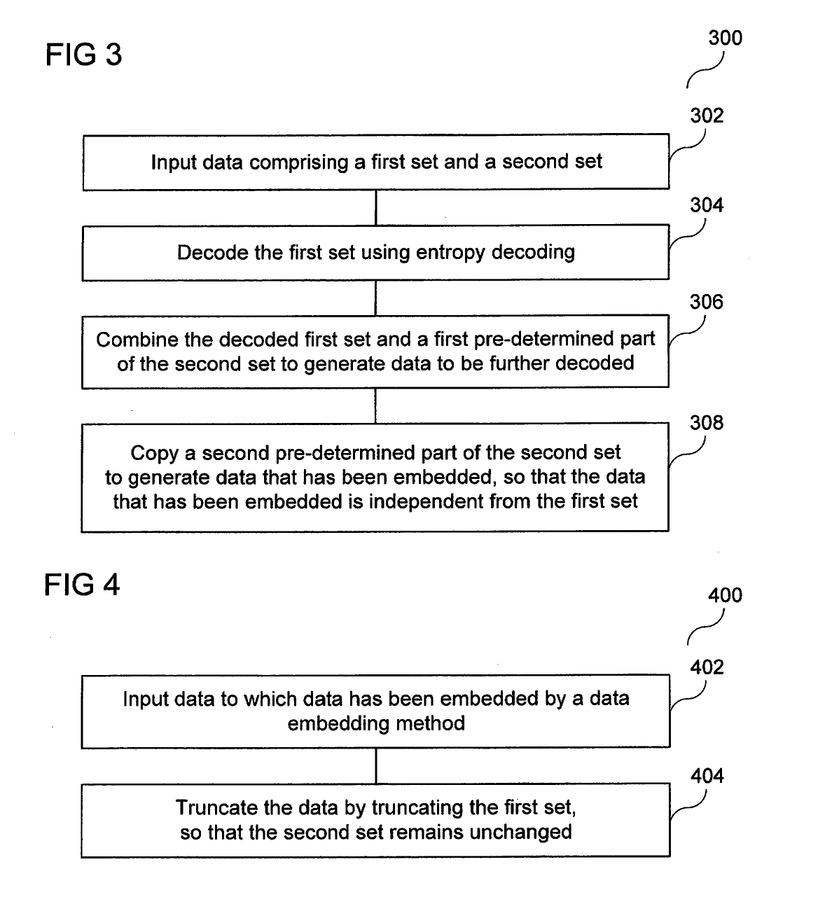

FIG. 3 shows a flow diagram 300 illustrating an embedded data extraction method according to an embodiment. In 302, data including a first set and a second set may be inputted. In 304, the first set may be decoded using entropy decoding. In 306, the decoded first set and a first pre-determined part of the second set may be combined to generate data to be further decoded. In 308, a second pre-determined part of the second set may be copied to generate data that has been embedded, so that the data that has been embedded is independent from the first set.

In various embodiments, the first set may be BPGC/CBAC coded data, as will be explained below.

In various embodiments, the decoded data may include data selected from a list consisting of: audio data; video data; transformation coefficients of audio data; Fourier transform coefficients of audio data; cosine transformation coefficients of audio data; discrete cosine transformation coefficients of audio data; modified discrete cosine transformation coefficients of audio data; integer modified discrete cosine transformation coefficients of audio data; discrete sine transformation coefficients of audio data; wavelet transformation coefficients of audio data; discrete wavelet transformation coefficients of audio data; transformation coefficients of video data; Fourier transform coefficients of video data; cosine transformation coefficients of video data; discrete cosine transformation coefficients of video data; modified discrete cosine transformation coefficients of video data; integer modified discrete cosine transformation coefficients of video data; discrete sine transformation coefficients of video data; wavelet transformation coefficients of video data; and discrete wavelet transformation coefficients of video data.

In various embodiments, the decoded data may include a plurality of data items.

In various embodiments, each data item may represent a transform coefficient.

In various embodiments, each transform coefficient may represent a frequency of audio data represented by the data to be decoded.

In various embodiments, data to be extracted may be extracted from the data to be decoded by copying parts of the second set, from data related to a high frequency to data related to a low frequency.

In various embodiments, data to be extracted may be extracted from the data to be decoded by copying parts of the second set, from data related to a low frequency to data related to a high frequency.

In various embodiments, the decoded data may be provided in bit-planes for each of the plurality of data items.

In various embodiments, the first set and the second set may be disjoint.

In various embodiments, the set union of the first set and the second set may be the data to be decoded.

In various embodiments, the second set may be grouped into a third set and a fourth set.

In various embodiments, the third set may be lazy mode coded data, as will be explained below.

In various embodiments, the fourth set may be the LEMC coded data, as will be explained below.

In various embodiments, the generated data that has been embedded may be independent from the third set.

In various embodiments, the generated data that has been embedded may be independent from the fourth set.

In various embodiments, the generated data that has been embedded may be independent from data items of the third set with less than a pre-determined number of bit-planes.

In various embodiments, the third set and the fourth set may be disjoint.

In various embodiments, the set union of the third set and the fourth set may be the second set.

In various embodiments, the embedded data extraction method may further include context-based entropy decoding of the first set.

In various embodiments, entropy decoding may include Huffman decoding.

In various embodiments, entropy decoding may include arithmetic decoding.

In various embodiments, entropy decoding may include context-based arithmetic coding.

In various embodiments, the embedded data extraction method may further include outputting the third set, without further decoding.

In various embodiments, the embedded data extraction method may further include low energy mode decoding of the fourth set.

In various embodiments, the data that has been embedded may include at least one of data selected from a list of: image data; text data; and encoded audio data.

FIG. 4 shows a flow diagram 400 illustrating a truncation method according to an embodiment. In 402, data to which data has been embedded by a data embedding, for example one of the data embedding methods described above, may be inputted. In 404, the data may be truncated by truncating the first set, so that the second set remains unchanged.

FIG. 5 shows a data embedding device 500 according to an embodiment. The data embedding device 500 may include an input circuit 502 configured to input data to be encoded and data to be embedded; a grouping circuit 504 configured to group the data to be encoded into a first set and a second set, based on an entropy of the data to be encoded; and an embedding circuit 506 configured to embed the data to be embedded into the data to be encoded by replacing a pre-determined part of the second set with the data to be encoded so that the first set remains free of data to be embedded. The input circuit 502, the grouping circuit 504 and the embedding circuit 506 may be may be coupled with each other, e.g. via an electrical connection 508 such as e.g. a cable or a computer bus or via any other suitable electrical connection to exchange electrical signals.

In various embodiments, an entropy of the data to be encoded may be computed based on the radio of the sum of absolute values of the data and the length of the data.

In various embodiments, the first set may be BPGC/CBAC coded data, as will be explained below.

In various embodiments, the data to be encoded may include data selected from a list consisting of: audio data; video data; transformation coefficients of audio data; Fourier transform coefficients of audio data; cosine transformation coefficients of audio data; discrete cosine transformation coefficients of audio data; modified discrete cosine transformation coefficients of audio data; integer modified discrete cosine transformation coefficients of audio data; discrete sine transformation coefficients of audio data; wavelet transformation coefficients of audio data; discrete wavelet transformation coefficients of audio data; transformation coefficients of video data; Fourier transform coefficients of video data; cosine transformation coefficients of video data; discrete cosine transformation coefficients of video data; modified discrete cosine transformation coefficients of video data; integer modified discrete cosine transformation coefficients of video data; discrete sine transformation coefficients of video data; wavelet transformation coefficients of video data; and discrete wavelet transformation coefficients of video data.

In various embodiments, the data to be encoded may include a plurality of data items.

In various embodiments, each data item may represent a transform coefficient.

In various embodiments, each transform coefficient may represent a frequency of audio data represented by the data to be encoded.

In various embodiments, data to be embedded may be embedded in the data to be encoded by replacing pre-determined parts of the second set, from a high frequency to a low frequency.

In various embodiments, data to be embedded may be embedded in the data to be encoded by replacing pre-determined parts of the second set, from a low frequency to a high frequency.

In various embodiments, the data to be encoded may be provided in bit-planes for each of the plurality of data items.

In various embodiments, the first set and the second set may be disjoint.

In various embodiments, the set union of the first set and the second set may be the data to be encoded.

In various embodiments, the grouping circuit 504 may further be configured to group the second set into a third set and a fourth set, based on the entropy of the data to be encoded.

In various embodiments, the third set may be lazy mode coded data, as will be explained below.

In various embodiments, the fourth set may be the LEMC coded data, as will be explained below.

In various embodiments, the embedding circuit 506 may further be configured to embed the data to be embedded into the data to be encoded so that the third set remains free of data to be embedded.

In various embodiments, the embedding circuit 506 may further be configured to embed the data to be embedded into the data to be encoded so that the fourth set remains free of data to be embedded.

In various embodiments, the embedding circuit 506 may further be configured to embed the data to be embedded into the data to be encoded so that the data items of the third set with less than a pre-determined number of bit-planes remain free of data to be embedded.

In various embodiments, the third set and the fourth set may be disjoint.

In various embodiments, the set union of the third set and the fourth set may be the second set.

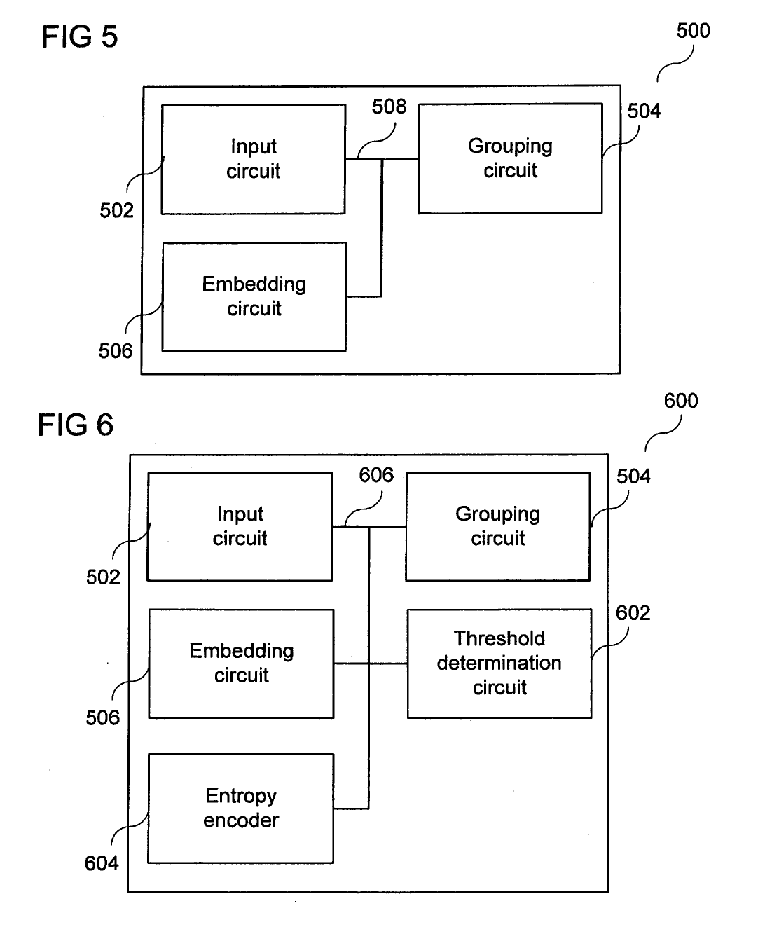

FIG. 6 shows a data embedding device 600 according to an embodiment. The data embedding device 600 may, similar to the data embedding device 500 shown in FIG. 5, include an input circuit 502, a grouping circuit 504, and an embedding circuit 506. The data embedding device 600 may further include a threshold determination circuit 602, as will be explained below. The data embedding device 600 may further include an entropy encoder 604, as will be explained below. The input circuit 502, the grouping circuit 504 the embedding circuit 506, the threshold determination circuit 602 and the entropy encoder 604 may be may be coupled with each other, e.g. via an electrical connection 606 such as e.g. a cable or a computer bus or via any other suitable electrical connection to exchange electrical signals.

In various embodiments, the threshold determination circuit 602 may be configured to determine a threshold based on the entropy of the data to be encoded.

In various embodiments, the threshold determination circuit 602 may be configured to determine a respective threshold for each of the plurality of data items based on the entropy of the data to be encoded.

In various embodiments, each data item may represent a scalefactor band, as will be explained below.

In various embodiments, the threshold determination circuit 602 may be configured to determine the respective thresholds L[s] of the respective data item s according to:

L[s]=max{L′εZ|(2^{m[s]-L′]+1}·N[s])≧A[s]},

wherein Z may be the positive and negative integer numbers, m[s] may be the total number of the bit-planes in the scalefactor band, N[s] may be the length of the data vector to be encoded, and A[s] may be the sum of the absolute values of the data vectors to be encoded.

In various embodiments, the grouping circuit 504 may further be configured to group the data to be encoded into the first set and the second set, based on the respective thresholds determined by the threshold determination circuit 602.

In various embodiments, the grouping circuit 504 may further be configured to group a data item into the first set, if the number of bit-planes of the data item is higher than the threshold for the data item.

In various embodiments, the grouping circuit 504 may further be configured to group a data item into the second set, if the number of bit-planes of the data item is lower to or equal than the threshold for the data item.

In various embodiments, the grouping circuit 504 may further be configured to group the first pre-determined number of bit-planes of a data item into the first set, if the number of bit-planes of the data item is higher than the threshold for the data item.

In various embodiments, the pre-determined number of bit-planes may be equal to the value of the respective threshold.

In various embodiments, the grouping circuit 504 may further be configured to group the last but the first pre-determined number of bit-planes of a data item into the second set, if the number of bit-planes of the data item is higher than the threshold for the data item.

In various embodiments, the grouping circuit 504 may further be configured to group a data item into the second set, if the number of bit-planes of the data item is lower or equal than the threshold for the data item.

In various embodiments, the grouping circuit 504 may further be configured to group the last but the first pre-determined number of bit-planes of a data item into the third set, if the number of bit-planes of the data item is higher than the threshold for the data item.

In various embodiments, the grouping circuit 504 may further be configured to group a data item into the fourth set, if the number of bit-planes of the data item is lower or equal than the threshold for the data item.

In various embodiments, the entropy encoder 604 may be configured to perform entropy encoding of the first set.

In various embodiments, the entropy encoder 604 may be configured to perform a context-based entropy encoding of the first set.

In various embodiments, the entropy encoder 604 may be configured to perform Huffman encoding.

In various embodiments, the entropy encoder 604 may be configured to perform arithmetic encoding.

In various embodiments, the entropy encoder 604 may be configured to perform context-based arithmetic coding.

In various embodiments, the embedding circuit 506 may further be configured to embed the data to be embedded into the data to be encoded so that the fourth set remains free of data to be embedded, and the data embedding device 600 may further include an outputting circuit configured to output the third set, without further encoding.

In various embodiments, the entropy encoder 604 may be configured to perform low energy mode coding of the fourth set.

In various embodiments, the data to be embedded may include at least one of data selected from a list of: image data; text data; and encoded audio data.

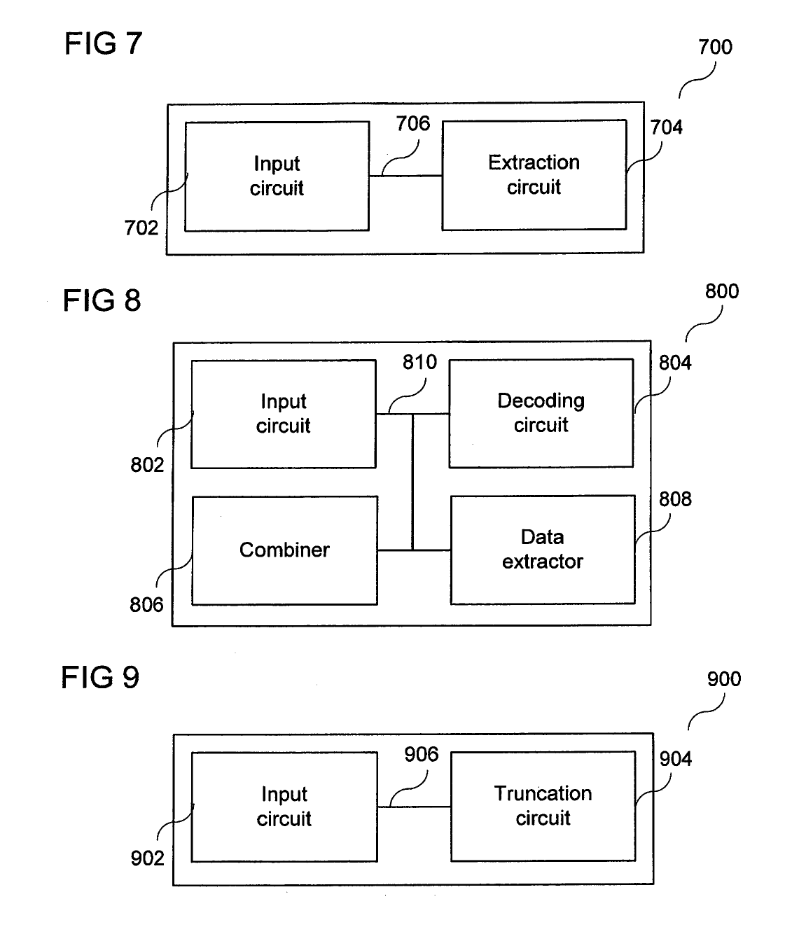

FIG. 7 shows an embedded data extraction device 700 according to an embodiment. The embedded data extraction device 700 may include an input circuit configured to input data to which data has been embedded by a data embedding device, for example by one of the data embedding devices described above, and an extraction circuit 704 configured to extract the embedded data from the second set by copying the pre-determined part of the second set. The input circuit 702 and the extraction circuit 704 may be may be coupled with each other, e.g. via an electrical connection 706 such as e.g. a cable or a computer bus or via any other suitable electrical connection to exchange electrical signals.

FIG. 8 shows an embedded data extraction device 800 according to an embodiment. The embedded data extraction device 800 may include an input circuit 802 configured to input data including a first set and a second set, a decoding circuit 804 configured to decode the first set using entropy decoding; a combiner 806 configured to combine the decoded first set and a first pre-determined part of the second set to generate data to be further decoded; and a data extractor 808 configured to copy a second pre-determined part of the second set to generate data that has been embedded, so that the data that has been embedded is independent from the first set. The input circuit 802, the decoding circuit 804, the combiner 806 and the data extractor 808 may be may be coupled with each other, e.g. via an electrical connection 810 such as e.g. a cable or a computer bus or via any other suitable electrical connection to exchange electrical signals.

In various embodiments, the first set may be BPGC/CBAC coded data, as will be explained below.

In various embodiments, the decoded data may include data selected from a list consisting of: audio data; video data; transformation coefficients of audio data; Fourier transform coefficients of audio data; cosine transformation coefficients of audio data; discrete cosine transformation coefficients of audio data; modified discrete cosine transformation coefficients of audio data; integer modified discrete cosine transformation coefficients of audio data; discrete sine transformation coefficients of audio data; wavelet transformation coefficients of audio data; discrete wavelet transformation coefficients of audio data; transformation coefficients of video data; Fourier transform coefficients of video data; cosine transformation coefficients of video data; discrete cosine transformation coefficients of video data; modified discrete cosine transformation coefficients of video data; integer modified discrete cosine transformation coefficients of video data; discrete sine transformation coefficients of video data; wavelet transformation coefficients of video data; and discrete wavelet transformation coefficients of video data.

In various embodiments, the decoded data may include a plurality of data items.

In various embodiments, each data item may represent a transform coefficient.

In various embodiments, each transform coefficient may represent a frequency of audio data represented by the data to be decoded.

In various embodiments, the generated data that has been embedded may be copied from the second set, from a high frequency to a low frequency.

In various embodiments, the generated data that has been embedded may be copied from the second set, from a low frequency to a high frequency.

In various embodiments, the decoded data may be provided in bit-planes for each of the plurality of data items.

In various embodiments, the first set and the second set may be disjoint.

In various embodiments, the set union of the first set and the second set may be the data to be decoded.

In various embodiments, the second set may be grouped into a third set and a fourth set.

In various embodiments, the third set may be lazy mode coded data, as will be explained below.

In various embodiments, the fourth set may be the LEMC coded data, as will be explained below.

In various embodiments, the generated data that has been embedded may be independent from the third set.

In various embodiments, the generated data that has been embedded may be independent from the fourth set.

In various embodiments, the generated data that has been embedded may be independent from data items of the third set with less than a pre-determined number of bit-planes.

In various embodiments, the third set and the fourth set may be disjoint.

In various embodiments, the set union of the third set and the fourth set may be the second set.

In various embodiments, the embedded data extraction device 800 may further include an entropy decoder (not shown), configured to perform entropy decoding of the first set.

In various embodiments, the entropy decoder may be further configured to perform context-based entropy decoding of the first set.

In various embodiments, the entropy decoder may be further configured to perform Huffman decoding.

In various embodiments, the entropy decoder may be further configured to perform arithmetic decoding.

In various embodiments, the entropy decoder may be further configured to perform context-based arithmetic coding.

In various embodiments, the embedded data extraction device 800 may be further configured to output the third set, without further decoding.

In various embodiments, the embedded data extraction device 800 may further include a low energy mode decoder configured to perform low energy mode decoding of the fourth set.

In various embodiments, the data that has been embedded may include at least one of data selected from a list of: image data; text data; and encoded audio data.

FIG. 9 shows a truncation device 900 according to an embodiment. The truncation device 900 may include an input circuit 902 configured to input data to which data has been embedded by a data embedding device, for example by one of the data embedding devices described above; and a truncation circuit 904 configured to truncate the data by truncating the first set, so that the second set remains unchanged. The input circuit 902 and the truncation circuit 904 may be may be coupled with each other, e.g. via an electrical connection 906 such as e.g. a cable or a computer bus or via any other suitable electrical connection to exchange electrical signals.

According to various embodiments, methods and devices for information embedding in scalable lossless audio may be provided.

According to various embodiments, an information embedding (IE) audio coder and decoder, for example, an IE audio coder and decoder based on a scalable lossless (SLS) coding and decoding system may be provided. By replacing the last part of the bitstream in each frame with a fixed amount of embedded information, the bitstream may be truncated without affecting the embedded information (which may be also referred to as info). By using the reserved bit to indicate the type of the bitstream, the decoder according to various embodiments may be backward compatible to the normal SLS bitstream. In addition, the information embedded bitstream may also be decoded by the normal SLS decoder with transparent quality output.

With advances in broadband networking and storage technologies, the capacities of more and more digital audio applications may be quickly approaching those for delivery of high sampling rate, high resolution digital audio at lossless quality. On the other hand, there may also be applications that desire highly compressed audio such as wireless devices. For example MPEG-4 scalable lossless (SLS) audio coding may be a unified solution for demands in high compression perceptual audio and high quality lossless audio. It may provide a fine-grain scalable extension to the MPEG-4 advanced audio coding (AAC) perceptual audio coder up to fully lossless reconstruction.

Like most of the perceptual audio coders, SLS may be able to provide the transparent-quality audio that may be indistinguishable with the original CD audio at a lossy bitrate (transparent bitrate). The bits beyond the transparent bitrate up to lossless may be thus exploited to store other useful information such as lyrics, music notes, cover art, surround audio side information or other audio auxiliary data, whilst maintaining the compatibility to the legacy decoder without changing the standard bitstream syntax. A further application of this information embedding is interactive music format.

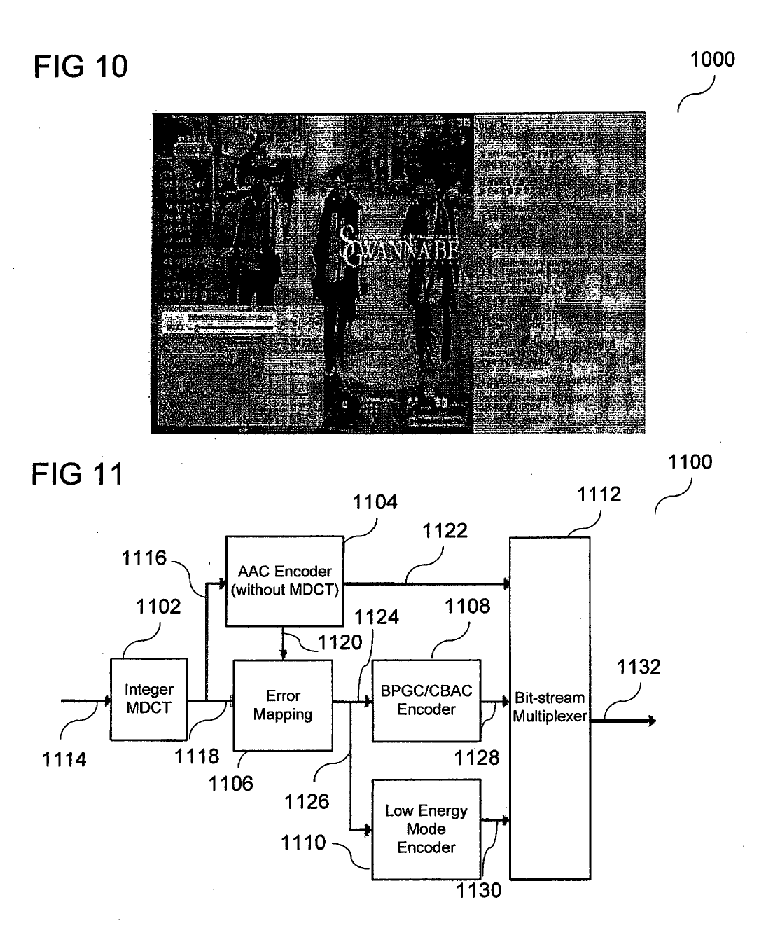

FIG. 10 shows an example of embedded data 1000 according to an embodiment. The data 1000 may for example be provided in example interactive music player with display of cover art, lyrics and interactive multi-track remix functions.

With an interface of an interactive music player in accordance with various embodiments as shown in FIG. 10, the enjoyment of music may be enriched with the visual effect (e.g., cover art, video) and the related information (e.g., interactive lyrics). In addition, there may be an “interactive mixing function” for the format such that the user may be able to remix the different components of the music (e.g., vocal track, pure music track and tracks of different instruments) with a personalized style.

According to various embodiments, SLS may include or consist of two separate layers: the core layer and the lossless enhancement (LLE) layer.

FIG. 11 shows an encoder 1100 according to an embodiment. Input data 1114 may be provided to an integer modified discrete cosine transformation (MDCT) circuit 1102 configured to perform integer MDCT. The integer MDCT circuit 1102 may provide data 1116 to an AAC encoder 1104, that may perform AAC encoding (for example without MDCT), and data 1118 to an error mapping circuit 1106, that may perform error mapping. The AAC encoder 1104 may provide data 1122 to a bit-stream multiplexer 1112, and data 1120 to the error mapping circuit 1106. The error mapping circuit 1106 may provide data 1124 to an BPGC/CBAC encoder 1108, which may be configured to perform BPGC (bit-plane Golomb coding) and CBAC (context-based arithmetic coding), and data 1126 to a low energy mode encoder 1110, which may be configured to perform low energy mode coding (LEMC). The BPGC/CBAC encoder 1108 may provide data 1128 to the bit-stream multiplexer 1132. The low energy mode encoder 1130 may provide data 1130 to the bit-stream multiplexer 1132. The bit-stream multiplexer 1132 may output data 1132.

In an SLS encoder 1200 according to various embodiments, the input audio in integer PCM (Puls-Code-Modulation) format may be losslessly transformed into the frequency domain by using the IntMDCT (integer MDCT) which may be a lossless integer to integer transform that approximates the normal MDCT transform. The resulting coefficients may then be passed on to the AAC encoder 1104 to generate the core layer AAC bitstream. In the AAC encoder 1104, transformed coefficients may be first grouped into scalefactor bands (sibs). The coefficients may then be quantized with a non-uniform quantizer, for example with different quantization steps in different sibs to shape the quantization noise so that it can be best masked.

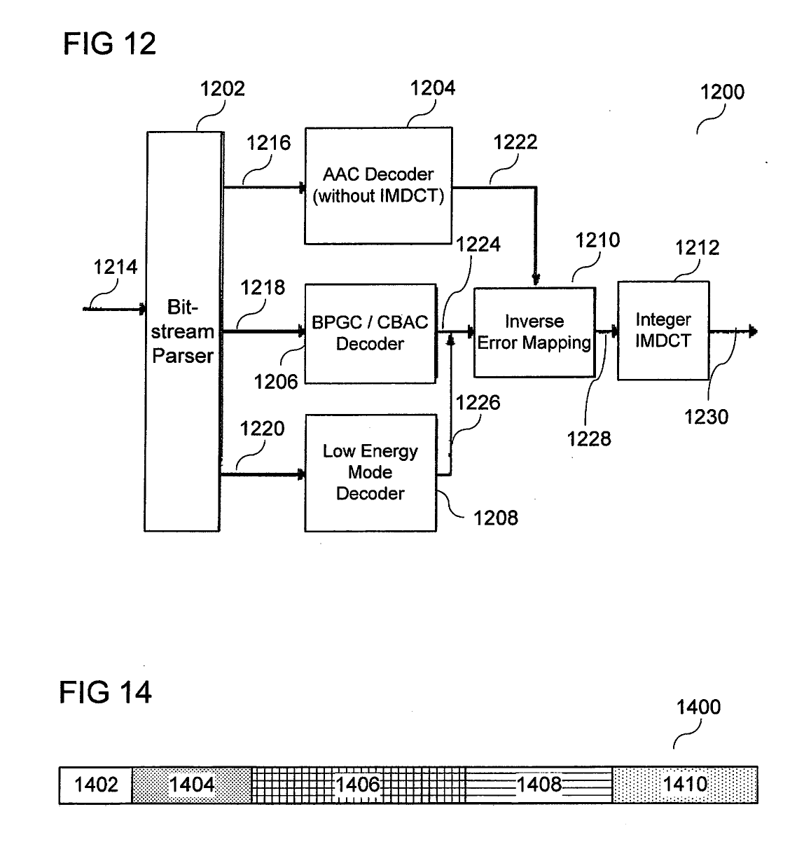

FIG. 12 shows a decoder 1200 according to an embodiment. Data 1214 may be input to a bit-stream parser 1202. The bit-stream-parser 1202 may output data 1216 to an AAC decoder 1204, which may be configured to perform AAC decoding, for example without IMDCT (Inverse MDCT). The bit-stream parser 1202 may further output data 1218 to an BPGC/CBAC decoder 1206, and data 1220 to a low energy mode decoder 1208. The AAC decoder 1204 may output data 1222 to an inverse error mapping circuit 1210, which may be configured to perform inverse error mapping. Furthermore, the BPGC/CBAC decoder 1206 may output data 1224 to the inverse error mapping circuit 1210, and the low energy mode decoder 1208 may output data 1226 to the inverse error mapping circuit 1210. The inverse error mapping circuit 1210 may output data 1228 to an integer IMDCT circuit, which may be configured to perform integer inverse IMDCT. The integer IMDCT circuit 1212 may output data 1230.

As depicted in FIG. 11 and FIG. 12, which for example may show the structure of MPEG-4 SLS encoder and decoder in accordance with various embodiments, the core layer may be an MPEG-4 AAC codec.

In order to efficiently utilize the information of the spectral data in the core layer bitstream, an error-mapping procedure may be employed to generate the residual spectrum coded in the LLE layer. This may be done by subtracting the AAC quantized spectrum from the original spectrum. For k={0, 1, . . . , N−1} where N may be the dimension of IntMDCT, the residual spectrum e[k] may be computed by

$$e [ k ] = \{ \begin{matrix}c [ k ] & i [ k ] = 0 \\ c [ k ] - ⌊ thr ( i [ k ] ) ⌋ & i [ k ] \neq 0.\end{matrix} \qquad ( 1 )$$

Here c[k] may be the IntMDCT coefficient, i[k] may be the quantized data vector produced by the AAC quantizer, └•┘:R→Z, where R may represent the set of the real number, and Z the set of (positive and negative) integer numbers, may be the flooring operation that rounds off a floating-point value to its nearest integer with a smaller amplitude and thr(i[k]) may be the low boundary (towards-zero side) of the quantization interval corresponding to i[k].

The residual spectrum may then be coded using bit-plane Golomb coding (BPGC) combined with context-based arithmetic coding (CBAC) and low energy mode coding (LEMC) to generate the scalable LLE layer bitstream. BPGC may be adopted in SLS as the major arithmetic coding scheme. Unlike most of bit-plane coding technologies that rely on adaptive arithmetic coding technology or fixed frequency table to determine the frequency assignment in coding the bit-plane symbols, BPGC may use a probability assignment rule that may be derived from the statistical properties (for example a Laplace distribution may be assumed) of the residual spectrum in SLS. The bit-plane symbol at bit-plane by may coded with probability assignment given by

$${Q}^{L [ s ]} [ bp ] = \{ \begin{matrix}\frac{1}{1 + {2}^{{2}^{L [ s ] - bp}}} & bp \leq L [ s ] \\ \frac{1}{2} & bp > L [ s ] ,\end{matrix} \qquad ( 2 )$$

where s (0≦s<S) may be the sfb and S may indicate the total number of the sfb. bp=1 may indicate the plane of most significant bit (MSB). Since coding of binary symbol with probability assignment ½ may be implemented by directly outputting input symbols to compressed bitstream, BPGC enters a lazy mode for bit-planes below L[s]. Therefore, L[s] and the bit-planes below may be referred to as the lazy planes. For each sib, L[s] may be selected using a pre-determined decision rule. For example, L[s] may be computed using a simplified adaptation rule as follows:

L[s]=max{L′εZ|(2^{m[s]-L′]+1}·N[s])≧A[s]}. (3)

where N[s] and A[s] may indicate the length and the sum of the absolute values of the data vectors to be coded, respectively. m[s] may be the total number of the bit-planes in the sib. Each bit-plane symbol may then be coded with an arithmetic coder using the probability assignment given by Q^{L[s]}[bp] except the sign symbols which are simply coded with probability assignment of ½.

As the frequency assignment rule of BPGC may be derived from the Laplace probability density function, BPGC may only deliver excellent compression performance when the sources may be near-Laplacian distributed. However, for some music items, there may exist some ‘silence’ time/frequency regions where the spectral data are in fact dominated by the rounding errors of IntMDCT. In order to improve the coding efficiency, LEMC may be adopted for coding signals from low energy regions. An sib may be defined as low energy if L[s]≧m[s].

It may also be possible to improve the coding efficiency of BPGC by further incorporating more sophisticated probability assignment rules that take into account the dependencies of the distribution of IntMDCT spectral data to several contexts such as their frequency locations or the amplitudes of adjacent spectral lines, which may be effectively captured by using CBAC. There may be one bit in the SLS bitstream to indicate whether BPGC or CBAC is applied.

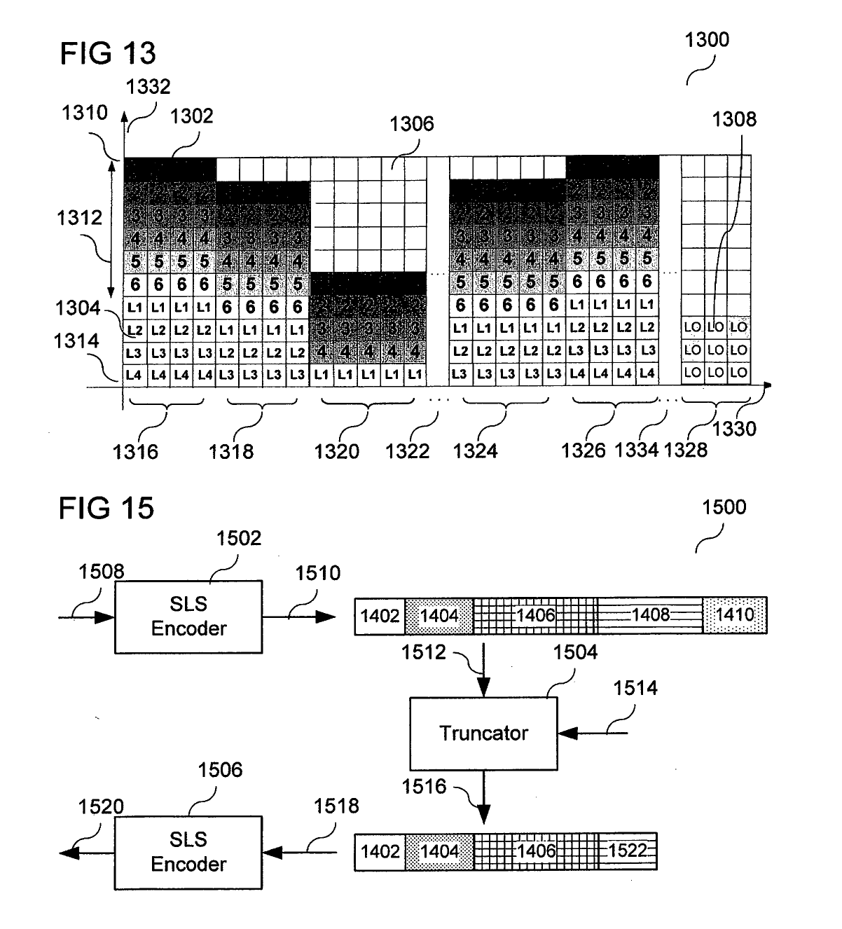

FIG. 13 shows a bit-plane coding sequence 1300 according to an embodiment.

In the overall bit-plane coding sequence 1300, for example in MPEG-4 SLS (for example using BPGC) as illustrated in FIG. 13, the scalefactor bands are shown over the horizontal axis 1330. For example, the zero-th sfb 1316, the first sfb 1318, the second sfb 1320, the fourteenth sfb 1324, and the fifteenth sfb 1326 are shown. Further sfbs (indicated by dots 1322 and dots 1334) may be provided. Scalefactor band S−1 may be indicated by reference sign 1328. For example, the zero-th sfb 1316 to the sfb S−1 (1330) may provide the IntMDCT residual spectrum.

The bit-plane coding in an SLS codec may be performed in a sequential order, where the plane of the MSB 1310 for spectral data from the lowest sfb to the highest sfb may be coded first. It may be followed by the subsequent bit-planes. Specifically, the first bit-plane for each sfb to be coded may be indicated by bp=1, the second may be bp 2, and so on. Once the normal bit-planes 1302 are completed using either BPGC or CBAC, they may be followed by the direct coding of the lazy bit-planes 1304 (without compression). The low energy bit-planes 1308 may be coded at last using LEMC until it reaches the plane of the least significant bit (LSB) 1314 for all sfbs. It is to be noted that leading zeros 1306 may not be coded. In each sfb, a pre-determined number 1312 of normal bit-planes may be provided, wherein the pre-determined number 1312 may vary from sfb to sfb.

In FIG. 13, the normal bit-planes 1302 may be denoted by their bit-plane number (for example “1”, “2”, . . . ), the lazy bit-planes 1304 may be denoted by their number with a leading “L” (for example “L1”, “L2”, . . . ), and the low energy bit-planes 1308 may be denoted by “LO”.

Finally, the LLE bitstream may be multiplexed with the core AAC bitstream to produce the final SLS bitstream. The bitstream structure is shown in FIG. 14.

FIG. 14 shows a bitstream structure 1400 according to an embodiment. For example, the bitstream structure 1400 of MPEG-4 SLS may include a header 1402, AAC coded data 1404, BPGC/CBAC coded data 1406, lazy mode coded data 1408, and LEMC coded data 1410.

Besides the codec structure, SLS may include a truncator function.

FIG. 15 shows an embodiment of truncation 1500. Input data 1508, for example input PCM samples, may be provided to a SLS encoder 1502, which may output encoded data 1510. The encoded data may be provided as a lossless bitstream, and may have the structure 1400 described with reference to FIG. 14, and duplicate description therefore may be omitted. Then the data may be input (as indicated by arrow 1512) to a truncator 1504. Furthermore, a target bitrate 1514 may be input to the truncator 1504. The truncator may then output (as indicated by arrow 1516) a truncated bitstream with target bitrate. The truncated bitstream may be unchanged with respect to the header 1402, the AAC coded data 1404 and the BPGC/CBAC coded data 1406, but may be truncated with respect to the lazy mode coded data 1408 and the LEMC coded data 1410, so that truncated data 1522 may be provided. The truncated bitstream may be input (as indicated by arrow 1518) to an SLS decoder 1506, which may output decoded data 1520, for example output PCM samples.

Thus, the SLS bitstream may be truncated by the truncator 1514 as shown in FIG. 15 to a lossy version with a target bitrate. The truncated bitstream may be decoded by a SLS decoder 1506, which may result in a lossy quality audio.

According to various embodiments, a coding system with information embedding may be provided that may be backward compatible to legacy SLS bitstream and decoder.

According to various embodiments, the embedded information may be available even if the embedded bitstream is truncated to a lower bitrate format.

According to various embodiments, the quality of the information embedded SLS audio may be transparent.

According to various embodiments, the coding system may have low complexity and trivial modification to the standardized codec as no additional psychoacoustic model may be needed.

According to various embodiments, the information embedding capacity may be pre-fixed regardless of the audio content.

According to various embodiments, there may be no size expansion of the embedded bitstream comparing to the legacy bitstream.

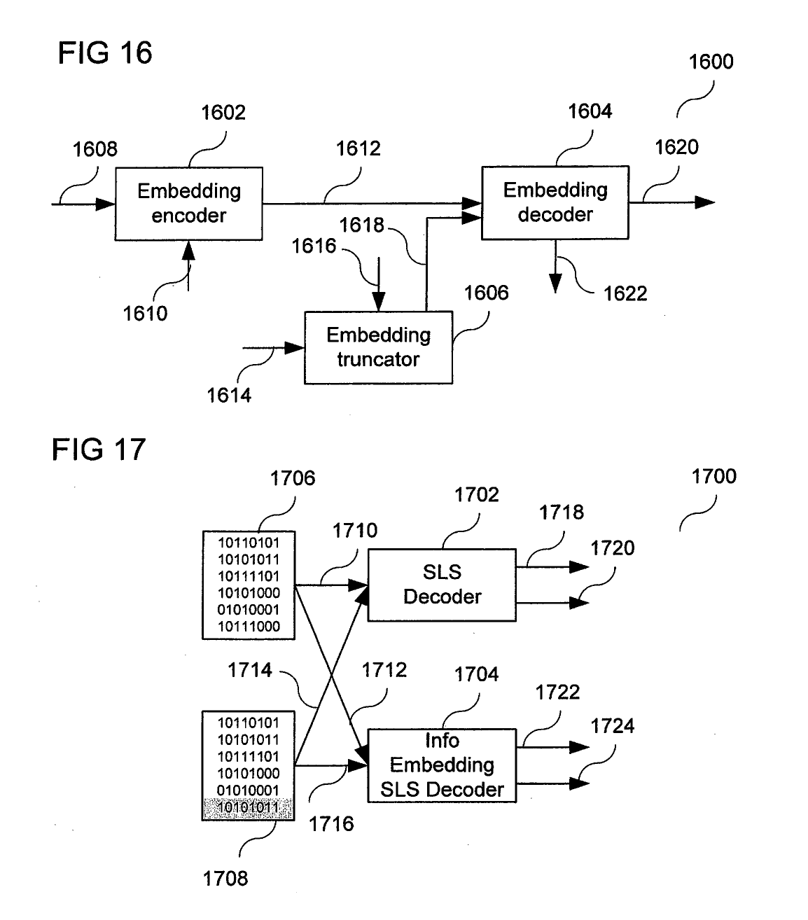

FIG. 16 shows a diagram 1600 illustrating the basic concept of embedding data according to an embodiment. The basic concept of the information embedding (IE) system is depicted in FIG. 16.

Input data 1608, for example input audio data (for example wave data (.wav)), may be input to an embedding encoder 1602, for example an information embedding SLS encoder. Furthermore, input extra information 1610, for example information to be embedded, may be provided to the embedding encoder 1602. The embedding encoder 1602 may provide data 1612, which may be encoded data with information embedded, to an embedding decoder 1604, which may output the output data 1620, for example output audio data (for example wave data (.wav)), and output extra information 1622. For example, the output data 1620 may correspond to the input data 1608, and the output extra information 1622 may correspond to the input extra information 1610.

Furthermore, encoded data 1614 with information embedded and a target bitrate 1616 may be provided to a information embedding truncator 1606. The truncator 1606 may truncate the input data 1614 to a bitrate 1616 and may output truncated data 1618 at the target bitrate 1616 to the embedding decoder 1604, which may decode the data 1618 to output data 1620, for example audio data (for example wave data (.wav)), and output extra information 1622. For example, the output data 1620 may correspond to a lossy version of the input data 1608, and the output extra information 1622 may correspond to the input extra information 1610.

The inputs to the IE SLS encoder 1602 may include the normal PCM input 1608 and the file 1610 which may contain the information to be embedded. The information embedded bitstream 1612 may be directly decoded by the IE SLS decoder 1604; it may be also truncated to a lower quality version by the IE truncator 1606 with the embedded information retained.

FIG. 17 shows a diagram 1700 illustrating the compatibility feature according to an embodiment. For example, as shown in the diagram 1700 illustrating the compatibility feature of an SLS information embedding system according to various embodiments, a SLS bitstream 1706, for example an MP4 bitstream, may be input to a SLS decoder 1702 as indicated by arrow 1710, so that the SLS decoder 1702 may output audio signals 1718 which may be obtained from decoding of the SLS bitstream 1706, or may be input to an information embedding SLS decoder 1704 as indicated by arrow 1712, so that the information embedding SLS decoder 1704 may output audio signals 1722, which may be obtained from decoding of the SLS bitstream 1706.

Furthermore, an information embedded SLS bitstream 1708, for example an MP4 bitstream, may be input to the SLS decoder 1702 as indicated by arrow 1714, so that the SLS decoder 1702 may output audio signals 1720 which may be obtained from decoding of the information embedded SLS bitstream 1708, or may be input to the information embedding SLS decoder 1704 as indicated by arrow 1716, so that the information embedding SLS decoder 1704 may output audio signals and embedded information 1724 which may be obtained from decoding and extracting embedded information of the information embedded SLS bitstream 1708.

The system according to various embodiments may be backward compatible to the legacy bitstream and decoder. As shown in FIG. 17, the IE SLS decoder 1704 may be able to decode the normal SLS bitstream 1706. Meanwhile, the normal SLS decoder 1702 may be able to decode the information embedded SLS bitstream 1708.

In various embodiments, the embedded information may be achievable even if the original information embedded bitstream is truncated by the truncator. To simplify the problem, it may be assumed that the bitrate of audio part of the truncated bitstream may be at least equal to the transparent bitrate. Otherwise, it may be hard to identify if the noise may be caused by insufficient bitrate or the embedded info.

In various embodiments, as depicted in FIG. 17, the perceptual quality of all 4 types of the output audio may remain transparent, also for the truncated versions.

In various embodiments, no additional psychoacoustic model may be required for the IE SLS encoder and decoder. Therefore, the additional complexity of the system according to various embodiments may be very low compared to the legacy SLS codec.

In various embodiments, the maximum amount of the information to be embedded may be independent of the audio content, i.e., the information embedding capacity may be pre-fixed.

For example, denote the bitrate of the lossless SLS bitstream by B₀ kbps (kilobits per second) and that of the information embedded SLS bitstream (for example defined as near-lossless) by B₁, then according to various embodiments, B₀=B₁ may hold. In other words, there may be no size expansion of the bitstream due to the embedded information, though the lossless property may not be retained.

According to various embodiments, four configurations may be provided in the system. In the fully backward compatible (FBC) configuration, all the above target features may be realized. To facilitate special use cases or requirements, there may be three subordinate configurations with the first feature partially or not realized, which may include: 1. backward compatible to bitstream (BCB) only; 2. backward compatible to the decoder (BCD) only; 3. not back-ward compatible (NBC) at all. In the following, the FBC configuration will be elaborated in details, and also the subordinate configurations will be described.

As indicated in FIG. 16, the methods and devices according to various embodiments may include three components: the IE SLS encoder, the IE truncator and the IE SLS decoder.

An information embedding SLS encoder according to various embodiments will be described below.

According to various embodiments, there may be two main issues for the IE encoder: how and how much the information shall be embedded in the bitstream. In the following, the way to embed information will be discussed, and the embedding capacity will also be described below.

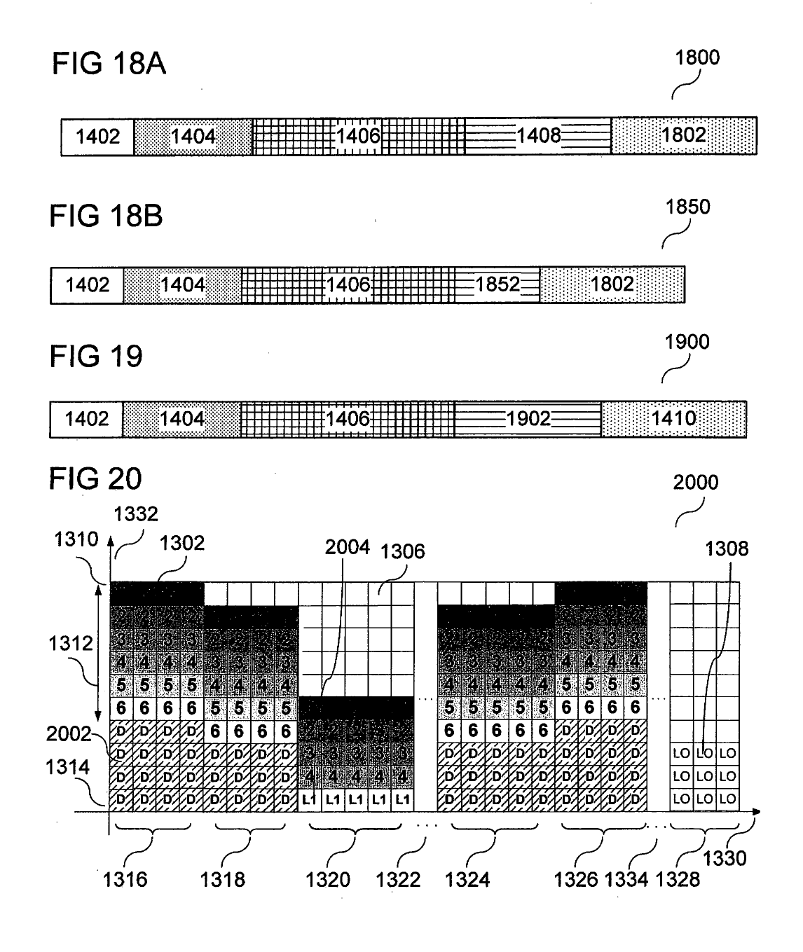

It may be observed from FIG. 13 that the SLS bitstream may actually be coded in a “perceptually prioritized” way. The BPGC/CBAC coded content may have the highest perceptual significance, followed by the lazy bit-planes and the LEMC content. The LEMC coded content may be considered perceptually insignificant due to its extremely low energy level and high frequency characteristic. It may also be depicted in FIG. 15 that the truncation may be performed from the LEMC content of the bitstream. According to various embodiments, in the IE SLS encoder, the information may be inserted from the back of the bitstream (for example as depicted in FIG. 18, as will be explained below) and the amount may be fixed to be N bytes, where N may be an integer number. This may be to facilitate the fixed amount of capacity and the operation of the IE truncator.

FIG. 18 shows a diagram 1800 illustrating an embedding method according to an embodiment. In the diagram 1800 illustrating for example an embedding method in information embedding SLS bitstream according to various embodiments, various fields may be identical to the bitstream structure as shown in FIG. 14, and duplicate description may be omitted. In the embedding method illustrated in FIG. 18, data may be embedded only in the LEMC coded data which may include N bytes of embedded information 1802. The overall length of the data shown in FIG. 18 may be L₁ bytes, with an integer number L₁.

FIG. 18B shows a diagram 1850 illustrating a truncation method according to an embodiment. In the diagram 1850 various fields may be identical to the bitstream structure as shown in FIG. 18, and duplicate description may be omitted. According to various embodiments, the bitstream structure may be truncated by truncating the lazy mode coded data 1408 to get truncated lazy mode coded data 1852, and appending the embedded data 1802 without modification.

According to various embodiments, in order to be backward compatible to the legacy bitstream, one bit for each frame (for example, a single channel may be assumed) may be desired to indicate if the bitstream is information embedded or not. There may be one reserved bit (for example default to be 0) in normal SLS bitstream. In the information embedded SLS bitstream, this bit may be written as 1.

In the following, an information embedding truncator according to various embodiments will be described.

Supposing that the SLS bitstream is to be truncated to Bₜ kbps, for the normal truncator, the bitstream length L^{t} (in byte) for each frame after truncation may be

$${L}^{t} = \frac{1000 \cdot {B}^{t} \cdot F}{8 \cdot S} , \qquad ( 4 )$$

where S may be the sampling rate and F may be the original frame length in bits. Thus, supposing that the SLS lossless bitstream length for a particular frame is L₀ bytes, it may be truncated by L₀-L^{t} to achieve the target bitrate of B^{t} kbps given that L₀>N. Otherwise, the frame may be not truncated. For the information embedded frame with L₁=L₀ and N bytes of extra information, the truncator may firstly count back N bytes from the end of information embedded frame and put them in the buffer. The remaining bitstream may be then truncated by L₁-L^{t} given that L^{t}≧N. Finally, the embedded information in the buffer may be re-attached to the end of the truncated bitstream. In this way, the information embedded may be still retained after truncation.

In the following, an information embedding SLS decoder according to various embodiments will be described.

As has been described above with reference to the IE (information embedding) encoder, there may be one bit to indicate if the bitstream is information embedded or not. If the bit is read to be 0, the IE SLS decoder may perform exactly the same as normal SLS decoder. If the bit is 1, the IE decoder may count back N bytes and read as the extra info. It may then decode the remaining bitstream as the normal SLS decoder.

In the following, the information embedding capacity according to various embodiments will be described.

According to various embodiments, there may be four scenarios for the IE bitstream:

1) The IE bitstream (near-lossless) may be directly decoded by the IE decoder.

2) The IE bitstream (near-lossless) may truncated by the IE truncator first, and decoded by the IE decoder.

3) The IE bitstream (near-lossless) may be directly decoded by normal SLS decoder.

4) The IE bitstream (near-lossless) may be truncated by the IE truncator first, and decoded by normal SLS decoder.

The IE (information embedding) capacity in terms of bytes per frame N for the above four scenarios may be defined as {N₁, N₁^{t}, N₀, N₀^{t}}, respectively, where index 1 may indicate that embedded information may be extracted, and index 0 may indicate that embedded information may not be extracted, and superscript t may indicate that the bitstream has been truncated. If all the scenarios are possible to happen, the real IE capacity may be limited by the smallest value among the four. As the total capacity for an audio piece may be desired to be a fixed amount, it may be assumed that each frame may be embedded with a fixed amount of N bytes, i.e., it may be not an average value. It may be further assumed that there may be no AAC core and the bitrate after truncation may be at least Bₜ kbps (for example, it may be assumed that this bitrate may be larger than the transparent bitrate for all the test sequences).

1) Case N₁:

The lossless SLS bitstream (or near-lossless for IE bitstream) may have different length for each frame. Supposing that the shortest frame length for a sequence may be L₁ bytes and the transparent bitrate for this sequence may be B₁^{t}, here the transparent quality may be achieved if

T₁[k]<M₁[k], ∀0≦k<K, (5)

where k and K may be the index and the total number of scalefactor bands, respectively. M₁[k] may be the psychoacoustic mask level of the sfb and T₁[k] may be the distortion induced by the truncation of the lossless bitstream to B₁^{t} kbps.

When the IE bitstream with N₁ of extra information is decoded by an IE SLS decoder, it may be the same as the case that the lossless bitstream is truncated by N₁ bytes and decoded by the normal SLS decoder. Thus, N₁ may be limited by

$${N}_{1} \leq {L}_{1} - \frac{1000 \cdot {B}_{1}^{t} \cdot F}{8 \cdot S} . \qquad ( 6 )$$

If

$${L}_{1} - \frac{1000 \cdot {B}_{1}^{t} \cdot F}{8 \cdot S} < {N}_{1} < {L}_{1} , \qquad ( 7 )$$

perceptible artifacts may appear in the decoded audio. Otherwise if N₁>L₁, the bitstream may not be decoded appropriately and the output audio may be corrupted.

2) Case N₁^{t}:

This case may be similar to the case of N₁. If the IE bitstream is truncated by an IE truncator with a minimum bitrate of Bₜ kbps, N₁^{t} may be limited by

$$\{ \begin{matrix}{N}_{1}^{t} \leq \frac{1000 \cdot ( {B}_{t} \cdot {B}_{1}^{t} ) \cdot F}{8 \cdot S} , & if {L}_{1} \geq \frac{1000 \cdot {B}_{t} \cdot F}{8 \cdot S} \\ {N}_{1}^{t} \leq {L}_{1} - \frac{1000 \cdot {B}_{1}^{t} \cdot F}{8 \cdot S} , & if {L}_{1} < \frac{1000 \cdot {B}_{t} \cdot F}{8 \cdot S} .\end{matrix} \qquad ( 8 )$$

3) Case N₀:

If an LE bitstream (near-lossless) is decoded by a normal SLS decoder, it may wrongly decode the embedded information as the audio info. The induced distortion T₀[s] may monotonically increases with N₀, i.e.,

$${\sum }_{k = 0}^{K - 1} {T}_{0} [ k ] = f ( {N}_{0} ) , {f}^{′} ( {N}_{0} ) > 0 , \qquad ( 9 )$$

where f(N₀) may be a function of N_{O}, and f′ may be the derivative of f. To retain a transparent quality audio output, N_{O} may be indirectly limited by

T₀[k]<M₁[k], ∀0≦k<K. (10)

4) Case N₀^{t}:

This case may be similar to the case of N₀, but the impact of the distortion caused by N₀^{t} may be larger than N₀. For example, given that the IE bitstream is truncated by an IE truncator with a minimum bitrate of Bₜ kbps, T₀^{t}[s] caused may be computed as

$${\sum }_{k = 0}^{K - 1} {T}_{0}^{t} [ k ] = g ( {N}_{o}^{t} ) + {\sum }_{k = 0}^{K - 1} {T}_{t} [ k ] , \qquad ( 11 )$$

where Tₜ[s] may be the distortion purely caused by the truncation of the lossless bitstream to the length of

$$( \frac{1000 \cdot {B}_{t} \cdot F}{8 \cdot S} - {N}_{o}^{t} )$$

and g(N₀^{t}) may be a function of N₀^{t}·g′ may be the derivative of g. It may be further known that

g′(N₀^{t})>f′(N₀) (12)

This may be because if the bitstream is not truncated (case of N₀), the normal SLS decoder may only wrongly decode the embedded information as the LEMC or lazy mode content. However, if the bitstream is truncated, the embedded information may be wrongly decoded as higher bit-plane level of audio information (e.g., BPGC/CBAC content). Similarly, N₀^{t} may be indirectly limited by

T₀^{t}[k]<M₁[k], ∀0≦k<K. (13)

It may be expected that N₀^{t} may be the smallest value among the four scenarios.

The IE capacity of the four scenarios may be bounded by the conditions listed in Eqns. (6), (8), (10) and (13) above. For the FBC configuration where all the scenarios may happen, the LE capacity may be limited by the smallest value of the four. It may be observed that the condition equations of the IE capacity may not be directly computed. Therefore, the IE capacity may be obtained from extensive experimental results.

Besides the FBC configuration described above, several subordinate configurations may be provided according to various embodiments with partially realized compatibility or no compatibility (as shown in FIG. 17).

For a BCB configuration, one indication bit (the reserved bit in SLS encoder) in an IE SLS encoder may be desired to indicate if the bitstream is a normal or an IE SLS bitstream. The LE capacity may be limited by N₁ if there is no truncation and by N₁^{t} if there is truncation of the bitstream.

For BCD configuration, there may be no need for the indication bit. Thus this reserved bit may be used for other purpose. The IE capacity may be limited by N₀ and N₀^{t} for near-loss and truncated bitstream, respectively.

The only difference between the NBC and BCB configuration may be that the indication bit may not be needed for NBC. The IE capacity of NBC may be the same as that of BCB.

According to various embodiments, an information embedding structure based on MPEG-4 scalable lossless audio coding may be provided. By embedding the extra information at the end of the SLS bitstream, the new IE SLS bitstream may be able to carry at least 24 kbps of embedded information without affecting the quality of the decoded audio and maintaining the compatibility with the MPEG standardized SLS decoder. This may also be achieved with no size expansion of the bitstream and the embedded information may be available even if the IE bitstream is truncated by the proposed truncator.

According to various embodiments, perceptually guided information embedding in MPEG-4 scalable lossless bitstream may be provided.

According to various embodiments, methods and devices may be provided that allow the MPEG-4 SLS bitstream to hide data up to 532 kbps without affecting the decoded audio quality. The data may be any information like lyrics, CD cover art, surrounding information, video information, etc.

According to various embodiments, a codec (for example an encoder) according to various embodiments may have two inputs, which may include a PCM audio and a data file. After the perceptually guided information embedding, the data from the input file may be embedded in the information embedded (IE) SLS bitstream. The IE bitstream may be decoded by a decoder according to various embodiments or a normal decoder without affecting the quality of the decoded audio.

According to various embodiments, the amount of information to be embedded may be variable or may be fixed.

According to various embodiments, the embedding method may be perceptually guided, i.e., the way to embed the extra information may be based on the perceptual property of the audio frame.

According to various embodiments, two main configurations may be provided:

1) A variable amount information embedding (VE).

2) Fixed amount information embedding (FE)

FIG. 19 shows a diagram 1900 illustrating an embedding method according to an embodiment. In the diagram 1900 illustrating for example an embedding method in information embedding SLS bitstream according to various embodiments, various fields may be identical to the bitstream structure is shown in FIG. 14, and duplicate description may be omitted. In the embedding method illustrated in FIG. 19, data may be embedded only in the lazy mode coded data which may include embedded information 1902.

In the following, variable amount information embedding (VE) according to various embodiments will be described.

According to various embodiments, for encoding, to make the codec according to various embodiments backward compatible to the normal SLS bitstream, one reserved bit, which may be defined as follows, may be provided in the syntax of the normal SLS codec:
write_bits(&coder,0,1); /* lle_reserved_bit */

The bit may be used to indicate if the bitstream is normal (0) or special (1) in order to make the system compatible to normal SLS bitstream.

FIG. 20 shows a bit-plane coding sequence 2000 according to an embodiment. In FIG. 20, various data may be identical to the data described with reference to FIG. 13, for which the same reference signs may be used and duplicate description may be omitted.

According to various embodiments, the perceptually guided embedding procedures may be listed as follows:

1. For the first N bit-planes 1312 from MSB bit-plane 1310 (bit-plane 1) to bit-plane N, the audio information may be encoded using normal SLS encoding method (BPGC or CBAC) from sfb s (0≦s≦S−1).

2. After the first N bit-planes are coded, the information embedding may starts from bit-plane N+1. The maximum bit-plane level of s may be indicated by Mₛ (e.g., Mₛ=10 for s=0 (i.e. for the zero-th scalefactor band 1316 in FIG. 20). For s from 0 to S−1, if Mₛ≧N+1, the bit-plane N+1 may be embedded with the extra information. Otherwise, no extra information may be embedded for the sfb. After bit-plane N+1 is completed, the embedding may start from bit-plane N+2, and so on.

3. After all the lazy bit-planes are coded/embedded, the bit-planes in the low energy zone may be encoded normally (same as the normal SLS encoder).

4. The minimum value of N may be 4 for SLS with AAC core bitrate of 64 kbps and 5 for SLS non-core to guarantee transparent quality audio output for VE decoder.

5. The minimum value of N may be 5 for SLS with AAC core bitrate of 64 kbps and 6 for SLS normal decoder.

In the illustration 2000 of variable-amount perceptually guided information embedding, embedded data (which may also be referred to as side information), may be shown by the hatched area 2002.

According to various embodiments, data may not be embedded in scalefactor bands with less than a pre-determined number of bit-planes, for example as indicated by non-hatched area 2004.

According to various embodiments, for the VE decoder, if the reserved bit is found to be 0, the normal SLS decoding may be conducted.

According to various embodiments, if the reserved bit is found to be 1, the decoding may be conducted as follows:

1. For the first N bit-planes 1312 from MSB bit-plane 1310 (bit-plane 1) to bit-plane N, decoding using normal SLS decoding method (BPGC or CBAC) may be performed from sfb s (0≦s≦S−1).

2. After the first N bit-planes are decoded, the information extracting may start from bit-plane N+1. For s from 0 to S−1, if Mₛ≧N+1, the extra information may be extracted from bit-plane N+1. Otherwise, no extra information may be extracted for the sfb. After bit-plane N+1 is completed, the embedding will start from bit-plane N+2, and so on.

3. After all the lazy bit-planes are decoded/extracted, the bit-planes in the low energy zone may be decoded normally (same as the normal SLS decoder).

According to various embodiments, if the FE bitstream is decoded by normal SLS decoder, all the bit-planes may be decoded as audio information and the embedded information may not be extracted.

In the following, fixed amount information embedding (FE) according to various embodiments will be described.

According to various embodiments, the amount of information to be embedded may be fixed. For each frame (for example except a pre-determined number of first frames, for example the first 2 frames; for example, pre-determined frames of the first frames, for example the first 2 frames may be silent and it may be desired not to embed extra information in these frames) the embedding amount may be fixed at K bytes.

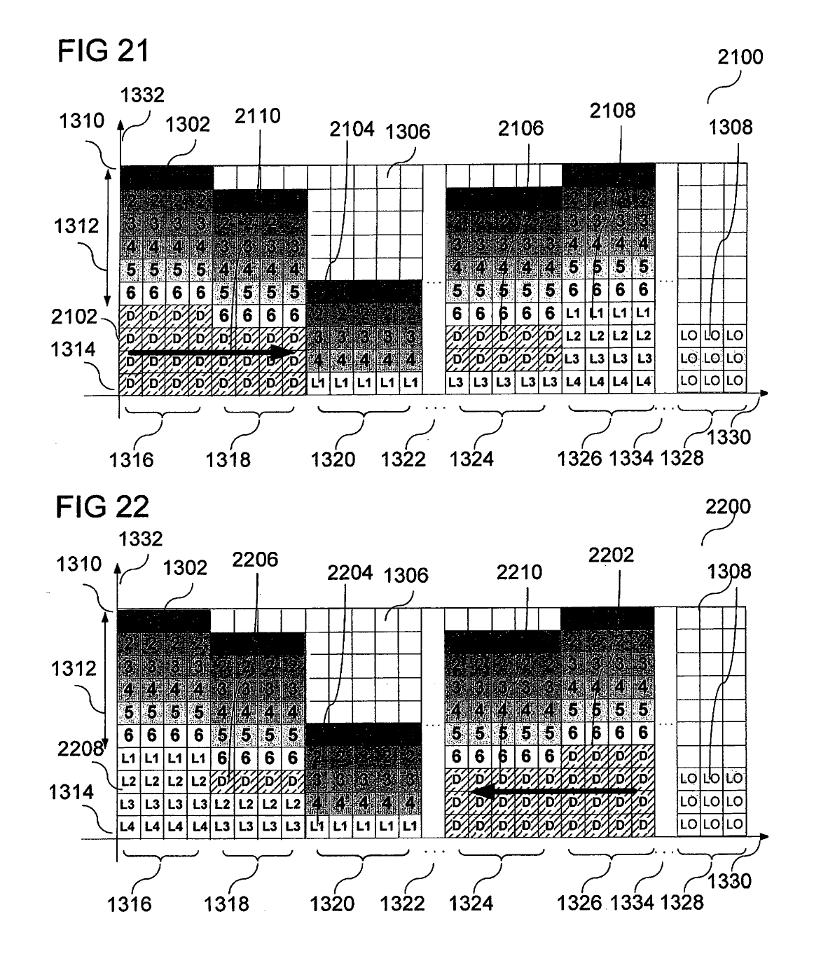

According to various embodiments, the embedding method may be similar to the one of VE, but the information embedding may stop once the amount of embedded information is K bytes. The embedding may start from the lowest sib towards the highest sib, or the opposite way (as indicated in FIG. 21 and FIG. 22, as will be explained below). According to various embodiments, starting from the highest sfb may result less affection to the low frequency region data.

FIG. 21 shows a bit-plane coding sequence 2100 according to an embodiment. In the illustration of fixed-amount perceptually guided information embedding from low sfb to high sib in FIG. 21, various data may be identical to the data described with reference to FIG. 13, for which the same reference signs may be used and duplicate description may be omitted. In FIG. 21, hatched blocks may indicate that data is embedded. As indicated by arrow 2110, data may be embedded from the low sfb to the high sfb. As shown by the hatched area 2102, data may be embedded in the zero-th sfb 1316 and in the first sfb 1318. No data may be embedded in sfb with less than a pre-determined number of bit-planes, as indicated by non-hatched area 2104. Furthermore, data may be embedded further to the higher sfbs, as long as the amount of data to be embedded has not been embedded yet. For example, in the fourteenth sfb 1324, data may be embedded in the first lazy bit-plane and in the second lazy bit-plane as shown by hatched area 2106, and no more data may be embedded in the third lazy bit-plane L3 of the fourteenth sfb 1324, and in the fifteenth sfb 1326 as shown by non-hatched area 2108.

FIG. 22 shows a bit-plane coding sequence 2200 according to an embodiment. In the illustration of fixed-amount perceptually guided information embedding from high sfb to low sfb in FIG. 22, various data may be identical to the data described with reference to FIG. 13, for which the same reference signs may be used and duplicate description may be omitted. In FIG. 22, hatched blocks indicate that data is embedded. As indicated by arrow 2210, data may be embedded from the high sfb to the low sfb. As shown by the hatched area 2202, data may be embedded in the fifteenth sfb 1326 and in the fourteenth sfb 1324. No data may be embedded in sfb with less than a pre-determined number of bit-planes, as indicated by non-hatched area 2204. Furthermore, data may be embedded further to the lower sfbs, as long as the amount of data to be embedded has not been embedded yet. For example, in the second sfb 1318, data may be embedded in the first lazy bit-plane as shown by hatched area 2206, and no more data may be embedded in the second lazy bit-plane L2 and third lazy bit-plane L3 of the first sfb 1318, and in the zero-th sfb 1316 as shown by non-hatched area 2208.

According to various embodiments, for the FE decoder, if the reserved bit is found to be 0, the normal SLS decoding may be conducted.

If the reserved bit is found to be 1, the special decoding may be conducted as follows:

1. For the first N bit-planes 1312 from MSB bit-plane 1310 (bit-plane 1) to bit-plane N, a normal SLS decoding method (BPGC or CBAC) may be performed from sfb s (0≦s≦S−1).

2. After the first N bit-planes are decoded, the information extracting may start from bit-plane N+1. For s from 0 to S−1 (or from S−1 to 0), if the total extracted information is less than K bytes and at the same time, Mₛ≧N+1, the extra information in the current sfb may be extracted from bit-plane N+1. Otherwise, no extra information may be extracted for the sfb. After bit-plane N+1 is completed, the embedding may start from bit-plane N+2, and so on.

3. After all the K bytes of extra information are extracted, the remaining bit-planes may be decoded normally (for example using the same method as the normal SLS decoder).

If the FE bitstream is decoded by normal SLS decoder, all the bit-planes may be decoded as audio information and the embedded information may not be extracted.

Tests have been conducted on the information embedding capacity of VE. The test sequences included 15 MPEG-4 standard test sequences (48 kHz/16 bit, frame length 1024), as listed in Table 1. The test sequences are coded at lossless bitrate with AAC core bitrate of 64 kbps. The results of the embedding and the quality measurement are summarized in Table 2, where ODG may indicate an Objective Difference Grade and NMR may indicate a Noise-To-Mask Ratio.

TABLE 1
MPEG-4 SLS Test Sequences

| No. | Name |
|---|---|
| 1 | avemaria |
| 2 | blackandtan |
| 3 | broadway |
| 4 | cherokee |
| 5 | clarinet |
| 6 | cymbal |
| 7 | dcymbals |
| 8 | etude |
| 9 | flute |
| 10 | fouronsix |
| 11 | haffner |
| 12 | mfv |
| 13 | unfo |
| 14 | violin |
| 15 | waltz |

TABLE 2
Information Embedding Capacity (kbps)

| | Capacity | | |
|---|---|---|---|
| No. | (kbps) | ODG | NMR |
| 1 | 199.40 | 0.00 | −21.21 |
| 2 | 457.75 | 0.04 | −20.93 |
| 3 | 348.79 | −0.12 | −18.98 |
| 4 | 416.25 | 0.06 | −21.41 |
| 5 | 317.46 | 0.05 | −20.76 |
| 6 | 125.92 | −0.10 | −16.60 |
| 7 | 532.76 | −0.06 | −19.24 |
| 8 | 234.91 | 0.04 | −21.25 |
| 9 | 216.82 | −0.07 | −20.12 |
| 10 | 324.45 | 0.03 | −20.72 |
| 11 | 430.71 | 0.06 | −21.22 |
| 12 | 98.83 | −0.10 | −19.27 |
| 13 | 406.26 | 0.06 | −21.27 |
| 14 | 335.58 | 0.01 | −20.30 |
| 15 | 421.68 | 0.07 | −21.49 |

According to various embodiments, methods and devices for embedding data may be provided that may be backward compatible to normal SLS codec, that may provide low complexity, that may support variable amount embedding, that may provide a compressed bitstream, that may provide a bitstream that may be truncated, that may provide no data expansion for the bitstream, that may support core and non-core mode of SLS, and that may provide high amount of hidden data without affection to the (audio) quality.

Applications of various embodiments may include music retrieval; music players (to display the related info); and effect upgrade (such as stereo music upgrade to surround/spatial music).

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-22. (canceled)

23. A data embedding method, comprising:
inputting data to be encoded and data to be embedded;
grouping the data to be encoded into a first set and a second set, based on an entropy of the data to be encoded; and
embedding the data to be embedded into the data to be encoded by replacing a pre-determined part of the second set with the data to be encoded so that the first set remains free of data to be embedded;
wherein the data to be encoded comprises a plurality of data items;
wherein the data to be encoded is provided in bit-planes for each of the plurality of data items;
wherein the data embedding method further comprises:
grouping the second set into a third set and a fourth set, based on the entropy of the data to be encoded;
wherein the data to be embedded into the data to be encoded is embedded so that the data items of the third set with less than a pre-determined number of bit-planes remain free of data to be embedded.

24. The data embedding method of claim 23,
wherein each data item represents a transform coefficient.

25. The data embedding method of claim 23,
wherein the data to be embedded into the data to be encoded is embedded so that the third set remains free of data to be embedded.

26. The data embedding method of claim 23,
wherein the data to be embedded into the data to be encoded is embedded so that the fourth set remains free of data to be embedded.

27. The data embedding method of claim 23,
wherein the data to be encoded comprises a plurality of data items; the method further comprising
determining a respective threshold for each of the plurality of data items based on the entropy of the data to be encoded.

28. The data embedding method of claim 27,
wherein grouping the data to be encoded into a first set and a second set further comprises grouping the data to be encoded into the first set and the second set, based on the determined respective thresholds.

29. The data embedding method of claim 23, further comprising:
entropy encoding of the first set.

30. The data embedding method of claim 23,
wherein the data to be embedded into the data to be encoded is embedded so that the fourth set remains free of data to be embedded,
the data embedding method further comprising:
outputting the third set, without further encoding.

31. An embedded data extraction method, comprising:
inputting data to which data has been embedded by the data embedding method of claim 23;
extracting the embedded data from the second set by copying the pre-determined part of the second set.

32. An embedded data extraction method, comprising:
inputting data comprising a first set and a second set;
decoding the first set using entropy decoding;
combining the decoded first set and a first pre-determined part of the second set to generate data to be further decoded; and
copying a second pre-determined part of the second set to generate data that has been embedded, so that the data that has been embedded is independent from the first set,
wherein the decoded data comprises a plurality of data items;
wherein the decoded data is provided in bit-planes for each of the plurality of data items; and
wherein the second set is grouped into a third set and a fourth set; and
wherein the generated data that has been embedded is independent from data items of the third set with less than a pre-determined number of bit-planes.

33. A truncation method, comprising:
inputting data to which data has been embedded by the data embedding method of claim 23; and
truncating the data by truncating the first set, so that the second set remains unchanged.

34. A data embedding device, comprising:
an input circuit configured to input data to be encoded and data to be embedded;
a grouping circuit configured to group the data to be encoded into a first set and a second set, based on an entropy of the data to be encoded; and
an embedding circuit configured to embed the data to be embedded into the data to be encoded by replacing a pre-determined part of the second set with the data to be encoded so that the first set remains free of data to be embedded;
wherein the data to be encoded comprises a plurality of data items;
wherein the data to be encoded is provided in bit-planes for each of the plurality of data items;
wherein the grouping circuit is further configured to group the second set into a third set and a fourth set, based on the entropy of the data to be encoded;
wherein the embedding circuit is further configured to embed the data to be embedded into the data to be encoded so that the data items of the third set with less than a pre-determined number of bit-planes remain free of data to be embedded.

35. The data embedding device of claim 34,
wherein each data item represents a transform coefficient.

36. The data embedding device of claim 34,
wherein the embedding circuit is further configured to embed the data to be embedded into the data to be encoded so that the third set remains free of data to be embedded.

37. The data embedding device of claim 34,
wherein the embedding circuit is further configured to embed the data to be embedded into the data to be encoded so that the fourth set remains free of data to be embedded.

38. The data embedding device of claim 34,
wherein the data to be encoded comprises a plurality of data items;
the device further comprising
a threshold determination circuit configured to determine a respective threshold for each of the plurality of data items based on the entropy of the data to be encoded.

39. The data embedding device of claim 38,
wherein the grouping circuit is further configured to group the data to be encoded into a first set and a second set further comprises grouping the data to be encoded into the first set and the second set, based on the respective thresholds determined by the threshold determination circuit.

40. The data embedding device of claim 34, further comprising:
an entropy encoder configured to perform entropy encoding of the first set.

41. The data embedding device of claim 34:
wherein the embedding circuit is further configured to embed the data to be embedded into the data to be encoded so that the fourth set remains free of data to be embedded,
the data embedding device further comprising:
an outputting circuit configured to output the third set, without further encoding.

42. An embedded data extraction device, comprising:
an input circuit configured to input data to which data has been embedded by the data embedding devices of claim 34;
an extraction circuit configured to extract the embedded data from the second set by copying the pre-determined part of the second set.

43. An embedded data extraction device, comprising:
an input circuit configured to input data comprising a first set and a second set;
a decoding circuit configured to decode the first set using entropy decoding;
a combiner configured to combine the decoded first set and a first pre-determined part of the second set to generate data to be further decoded; and
a data extractor configured to copy a second pre-determined part of the second set to generate data that has been embedded, so that the data that has been embedded is independent from the first set;
wherein the decoded data comprises a plurality of data items;
wherein the decoded data is provided in bit-planes for each of the plurality of data items; and
wherein the second set is grouped into a third set and a fourth set; and
wherein the generated data that has been embedded is independent from data items of the third set with less than a pre-determined number of bit-planes.

44. A truncation device, comprising:
an input circuit configured to input data to which data has been embedded by the data embedding device of claim 34; and
a truncation circuit configured to truncate the data by truncating the first set, so that the second set remains unchanged.
